(19) United States
(12) Patent Application Publication
(10) Pub. No.: US 2016/0216471 A1
(43) Pub. Date: Jul. 28, 2016

(54) FIBER OPTIC ASSEMBLIES WITH A FIBER OPTIC CABLE MOVABLE BETWEEN CABLE OPENINGS

(71) Applicant: CORNING OPTICAL COMMUNICATIONS LLC, Hickory, NC (US)

(72) Inventors: William Julius McPhil Giraud, Azle, TX (US); Diana Rodriguez, Fort Worth, TX (US)

(21) Appl. No.: 15/003,097

(22) Filed: Jan. 21, 2016

Related U.S. Application Data
(60) Provisional application No. 62/108,246, filed on Jan. 27, 2015.

(51) Int. Cl. G02B 6/44; G02B 6/38

(52) U.S. Cl. CPC G02B 6/4454; G02B 6/4477; G02B 6/3897; G02B 6/4452

(57) ABSTRACT

Fiber optic assemblies, including cassettes, with a fiber optic cable movable between cable openings, and related components, systems, and methods, are disclosed. A fiber optic assembly comprises a housing having a front end and a rear end and defining an interior space therein. The fiber optic assembly includes a plurality of cable openings in the housing. Each cable opening is configured to route a fiber optic cable connected to one of a plurality of adapters out of the interior space of the housing. The fiber optic assembly is configured to allow the fiber optic cable to be moved from one of the cable openings to another of the cable openings when one or both panels are moved into the open position.

### CROSS REFERENCE TO RELATED APPLICATIONS

This application claims the benefit of priority under U.S.C. 119 of U.S. Provisional Application Ser. No. 62/108,246, filed Jan. 27, 2015, the content of which is relied upon and incorporated herein by reference in its entirety.

### BACKGROUND

The technology of the disclosure relates to fiber optic modules provided in fiber optic equipment to support fiber optic connections, and in particular fiber optic assemblies, including cassettes, with a fiber optic cable movable between cable openings, and related components, systems, and methods.

Benefits of optical fiber use include extremely wide bandwidth and low noise operation. Because of these advantages, optical fiber is increasingly being used for a variety of applications, including but not limited to broadband voice, video, and data transmission. Fiber optic networks employing optical fiber are being developed and used to deliver voice, video, and data transmissions to subscribers over both private and public networks. These fiber optic networks often include separated connection points at which it is necessary to link optical fibers in order to provide “live fiber” from one connection point to another connection point. In this regard, fiber optic equipment is located in data distribution centers or central offices to support interconnections.

The fiber optic equipment is customized based on the application need. The fiber optic equipment is typically included in housings that are mounted in equipment racks to maximize space. One example of such fiber optic equipment is a fiber optic module. A fiber optic module is designed to provide cable-to-cable fiber optic connections and manage the polarity of fiber optic cable connections. The fiber optic module is typically mounted to a chassis which is then mounted inside an equipment rack or housing. The chassis may be provided in the form of a tray that is extendable from the equipment rack like a drawer. This allows a technician access to fiber optic adapters disposed in the fiber optic module and any fiber optic cables connected to the fiber optic adapters without removing the fiber optic module from the equipment rack.

Even with advancements in access to fiber optic modules, the labor associated with installing fiber optic modules and making optical connections is significant. For example, for a field technician to install a new fiber optic module, the field technician typically loads trunk cables in the rear section of a fiber optic equipment rack. The field technician then feeds the connectorized fanout legs from the trunk cable to the front of the equipment rack. The field technician then walks around to the front of the equipment rack to connect the fanout legs to a fiber optic module. Because data distribution centers are typically large facilities with significant numbers of equipment racks, walking back and forth from the rear section to the front section of the equipment rack during an installation can take significant time. Alternatively, a second technician may work in tandem with the first technician, where the first technician manages loading of fiber optic cables in the rear section of the equipment rack. The second technician remains in the front of the rack to install the fiber optic modules and establish optical connections between the fiber optic cables and the fiber optic modules. In either scenario, fiber optic cables are installed in the rear section of the equipment rack and the fiber optic modules and connections are installed from the front of the equipment rack thereby requiring extensive labor.

### SUMMARY

Fiber optic assemblies, including cassettes, with a fiber optic cable movable between cable openings, and related components, systems, and methods, are disclosed herein. In an embodiment, a fiber optic assembly comprises a housing having a front end and a rear end. The housing defines an interior space therein, having one or more access openings, with one or more panels connected to the housing and movable between a closed position and an open position. In the closed position, each panel covers a part of the access opening, with the open position permitting access to the interior space of the housing. The fiber optic assembly also includes a plurality of adapters, each having a front and a rear disposed in the front end of the housing. The front of each adapter is accessible from the front end of the housing when the fiber optic assembly is mounted in a fiber optic chassis. The fiber optic assembly also includes a plurality of cable openings in the housing. Each cable opening is configured to route a fiber optic cable connected to the plurality of adapters out of the interior space of the housing. In this embodiment, cable openings may be disposed in the sides of the housing, at the rear end of the housing, or in the front end of the housing. The fiber optic assembly is configured to allow the fiber optic cable to be moved from one of the cable openings to another of the cable openings when one or both panels are moved into the open position. One benefit of this arrangement is that a portion of a fiber optic cable, such as a pigtail cable, may be moved between a number of differently located cable openings, thereby allowing more versatility in routing fiber optic cables in and out of the housing of the fiber optic assembly.

In an exemplary embodiment, a fiber optic assembly is disclosed. The fiber optic assembly comprises a housing having a front end and a rear end, the housing defining an interior space therein. The fiber optic assembly further comprises at least one access opening in the housing. The fiber optic assembly further comprises at least one panel connected to the housing and movable between a closed position removably covering at least part of the at least one access opening, and an open position. The fiber optic assembly further comprises a plurality of adapters each having a front end and a rear end disposed in the front end of the housing such that the front end of each of the plurality of adapters is accessible from the front end of the housing when the fiber optic assembly is mounted in a fiber optic chassis. The fiber optic assembly further comprises a plurality of cable openings in the housing configured to route at least one fiber optic cable connected to at least one of the plurality of adapters out of the housing. The fiber optic assembly is configured to allow at least one fiber optic cable connected to at least one of the plurality of adapters to be moved from one of the plurality of cable openings to another of the plurality of cable openings when the panel is moved into the open position.

In another exemplary embodiment, a fiber optic chassis is disclosed. The fiber optic chassis comprises a housing defining an interior. The fiber optic chassis further comprises at least one fiber optic assembly mounted in the interior of the chassis. Each fiber optic assembly comprises a housing having a front end and a rear end, the housing defining an interior space therein. Each fiber optic assembly further comprises at least one access opening in the housing. Each fiber optic assembly further comprises at least one panel connected to the housing and movable between a closed position removably covering at least part of the at least one access opening, and an open position. Each fiber optic assembly further comprises a plurality of adapters each having a front end and a rear end disposed in the front end of the housing such that the front end of each of the plurality of adapters is accessible from the front end of the housing when the fiber optic assembly is mounted in a fiber optic chassis. Each fiber optic assembly further comprises a plurality of cable openings in the housing configured to route at least one fiber optic cable connected to at least one of the plurality of adapters out of the housing. Each fiber optic assembly is configured to allow at least one fiber optic cable connected to at least one of the plurality of adapters to be moved from one of the plurality of cable openings to another of the plurality of cable openings when the panel is moved into the open position.

In another exemplary embodiment, a method of reconfiguring a fiber optic assembly, the fiber optic assembly having a front end and a rear end and defining an interior space therein is disclosed. The method comprises accessing the interior space of the fiber optic assembly via at least one access opening in the housing. The method further comprises removing a fiber optic cable extending from one or more adapters disposed in the front end of the housing to an exterior of the housing through a first cable opening in the housing. The method further comprises disposing the fiber optic cable through a second cable opening in the housing such that the fiber optic cable extends from the one or more adapters disposed in the front end of the housing to an exterior of the housing through the second cable opening in the housing.

Additional features and advantages will be set forth in the detailed description which follows, and in part will be readily apparent to those skilled in the art from the description or recognized by practicing the embodiments as described in the written description and claims hereof, as well as the appended drawings.

It is to be understood that both the foregoing general description and the following detailed description are merely exemplary, and are intended to provide an overview or framework to understand the nature and character of the claims.

The accompanying drawings are included to provide a further understanding, and are incorporated in and constitute a part of this specification. The drawings illustrate one or more embodiment(s), and together with the description serve to explain principles and operation of the various embodiments.

### BRIEF DESCRIPTION OF THE DRAWINGS

FIGS. 1A and 1B are top and bottom perspective views of a fiber optic assembly having a plurality of cable openings for rerouting a fiber optic cable according to an embodiment;

FIGS. 2A-2C are detailed perspective views of the fiber optic assembly of FIGS. 1A and 1B illustrating an exemplary method of rerouting the fiber optic cable according to an embodiment;

FIGS. 3A and 3B are bottom schematic views of the fiber optic assembly of FIGS. 1A-2C illustrating strain relief features disposed between the slack storage areas and cable openings of the fiber optic assembly;

FIG. 4 is a rear perspective view of an exemplary fiber optic chassis having a plurality of fiber optic assemblies according to FIGS. 1A-3B mounted therein, with a rear adapter panel attached thereto;

FIG. 5 is a detailed perspective view of the rear adapter panel shown in FIG. 4 configured to mount to a fiber optic chassis;

FIG. 6 is a detailed perspective view of a front adapter panel configured to mount proximate a front end of a fiber optic chassis;

FIGS. 7A and 7B are front perspective and front schematic views of an exemplary fiber optic rack having the chassis of FIG. 4 mounted thereon;

FIGS. 8A and 8B are top schematic and rear perspective views of a fiber optic assembly having a housing with a plurality of multi-fiber connectors mounted in the rear thereof, according to an alternative embodiment; and

FIG. 9 is a front perspective view of a fiber optic assembly having a housing with single fiber and multi-fiber connectors mounted in the front thereof, according to an alternative embodiment.

### DETAILED DESCRIPTION

Fiber optic assemblies, including cassettes, with a fiber optic cable movable between cable openings, and related components, systems, and methods, are disclosed herein. In an embodiment, a fiber optic assembly comprises a housing having a front end and a rear end. The housing defines an interior space therein, having one or more access openings, with one or more panels connected to the housing and movable between a closed position and an open position. In the closed position, each panel covers a part of the access opening, with the open position permitting access to the interior space of the housing. The fiber optic assembly also includes a plurality of adapters, each having a front and a rear disposed in the front end of the housing. The front of each adapter is accessible from the front end of the housing when the fiber optic assembly is mounted in a fiber optic chassis. The fiber optic assembly also includes a plurality of cable openings in the housing. Each cable opening is configured to route a fiber optic cable connected to the plurality of adapters out of the interior space of the housing. In this embodiment, cable openings may be disposed in the sides of the housing, at the rear end of the housing, or in the front end of the housing. The fiber optic assembly is configured to allow the fiber optic cable to be moved from one of the cable openings to another of the cable openings when one or both panels are moved into the open position. One benefit of this arrangement is that a portion of a fiber optic cable, such as a pigtail cable, may be moved between a number of differently located cable openings, thereby allowing more versatility in routing fiber optic cables in and out of the housing of the fiber optic assembly.

As used herein, it is intended that the terms “fiber optic cable” and “optical cable” include all types of fiber optic cables and optical fibers including single mode and multi-mode light waveguides, and including one or more bare optical fibers, loose-tube optical fibers, tight-buffered optical fibers, ribbonized optical fibers, bend-insensitive optical fibers, or any other expedient of a medium for transmitting light signals, or as otherwise may be relevant to the specific context.

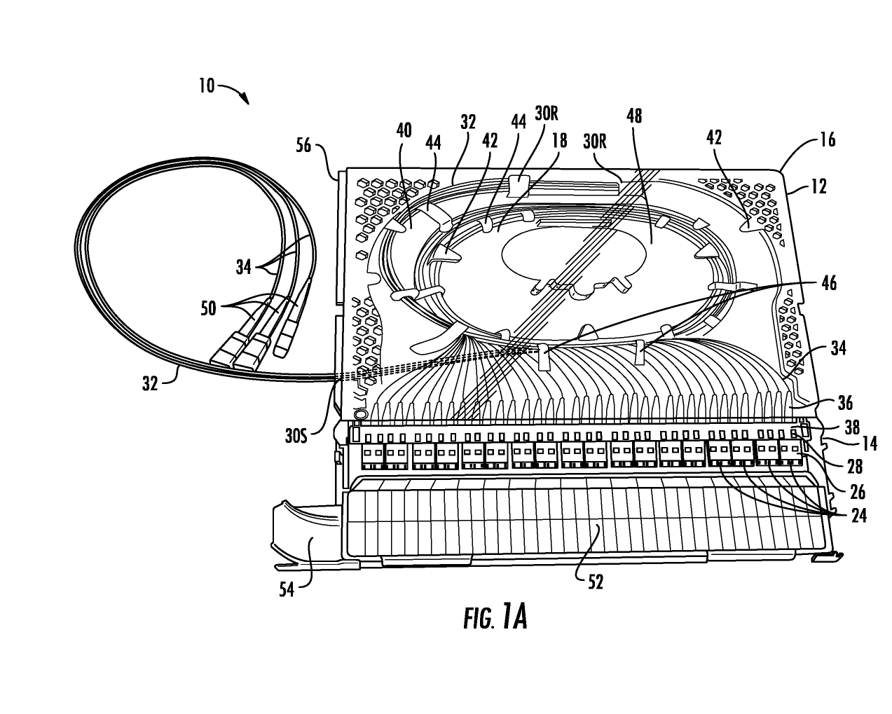

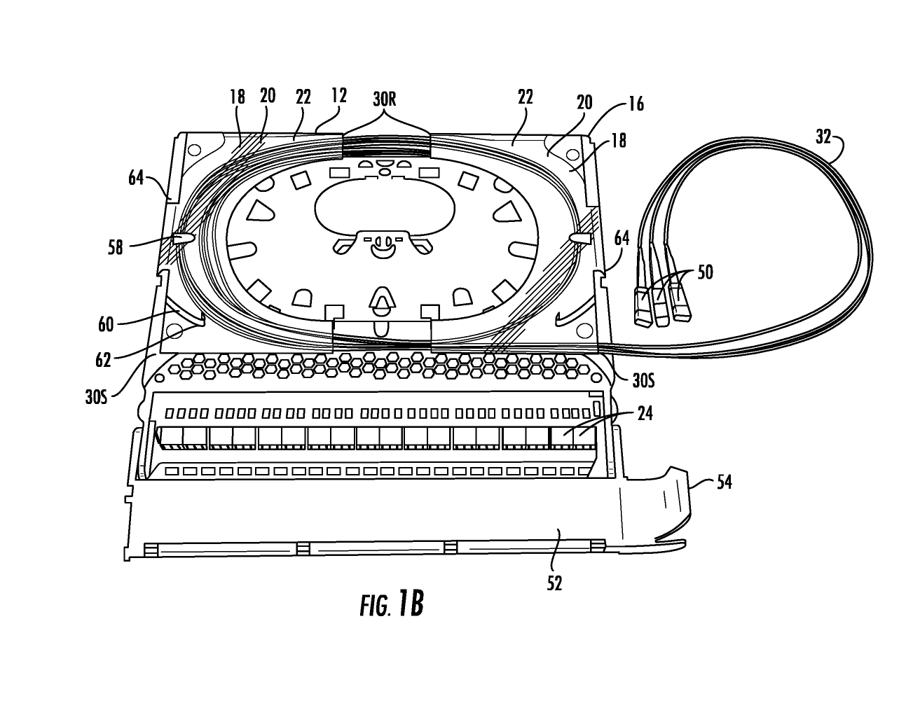

Embodiments of optical cable assemblies, such as cassettes, and systems and methods employing optical cable assemblies will now be described with reference to the figures. In this regard, FIGS. 1A and 1B illustrate a fiber optic assembly 10. The fiber optic assembly 10 comprises a housing 12 having a front end 14 and a rear end 16. The housing 12 defines an interior space 18 therein, having one or more access openings 20 (see FIG. 1B). In this embodiment, a pair of panels 22 (see FIG. 1B) is connected to the housing 12 and is movable between a closed position and an open position. In the closed position, each panel 22 covers a part of the access opening 20, with the open position permitting access to the interior space 18 of the housing 12.

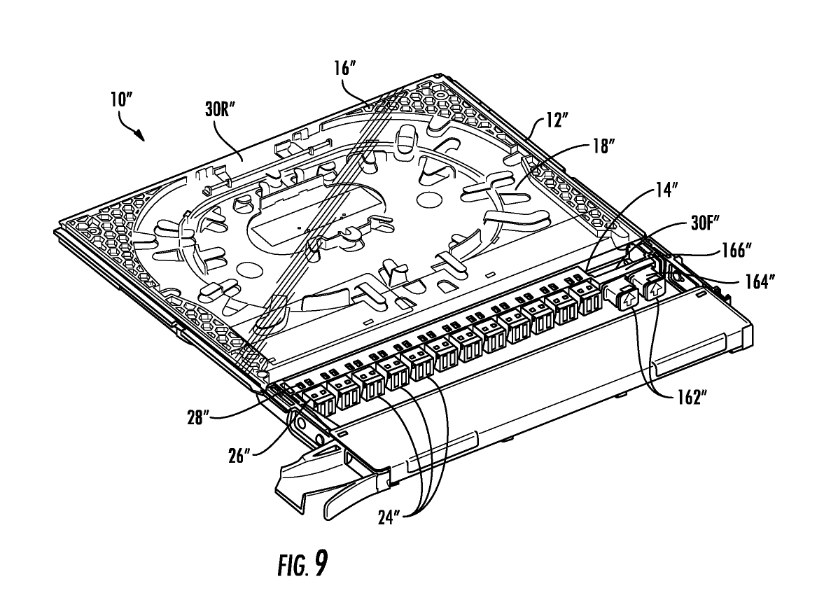

The fiber optic assembly 10 also includes a plurality of fiber optic adapters 24, each having a front 26 and a rear 28 disposed in the front end 14 of the housing 12. The front 26 of each fiber optic adapter 24 is accessible from the front end 14 of the housing 12 when the fiber optic assembly 10 is mounted in a fiber optic chassis (not shown). The fiber optic assembly 10 also includes a plurality of cable openings 30 in the housing 12. Each cable opening 30 is configured to route a fiber optic cable 32 connected to the plurality of fiber optic adapters 24 out of the interior space 18 of the housing 12. In this embodiment, cable openings 30 may be disposed in the sides of the housing 12 (see cable opening 30S), at the rear end 16 of the housing 12 (see cable opening 30R), or in the front end 14 of the housing 12 (see cable opening 30F″ shown in FIG. 9).

As will be described in detail below, the fiber optic assembly 10 is configured to allow the fiber optic cable 32 to be moved from one of the cable openings 30 to another of the cable openings 30 when one or both panels 22 are moved into the open position. One benefit of this arrangement is that a portion of a fiber optic cable, such as a pigtail cable, may be moved between a number of differently located cable openings, thereby allowing more versatility in routing fiber optic cables in and out of the housing 12 of fiber optic assembly 10.

As shown in FIG. 1A, fiber optic cable 32 may include a plurality of optical fibers 34 terminated by a plurality of fiber optic connectors 36. In this embodiment, the fiber optic connectors 36 are disposed in the rears 28 of a fiber optic adapters 24, which are in turn retained in an adapters retention structure 38 located at the front end 14 of housing 12. In addition, excess length of fiber optic cable 32 can be coiled and stored in a slack storage tray 40 disposed in the interior space 18 of housing 12. In this embodiment, slack storage tray 40 includes a plurality of cable retaining members 42 and retention clips 44 for retaining and guiding the excess length of fiber optic cable 32 in the slack storage tray 40. In addition, additional guide tabs 46 may also be used to guide individual optical fibers 34 between the slack storage tray 40 and the individual fiber optic adapters 24.

In this embodiment as well, a removable cover 48 covers and encloses the top of the housing 12, thus enclosing the fiber optic connectors 36 within the interior space 18 of the housing 12. The other end of fiber optic cable 32 is routed through and may be retained by a cable opening 30 (cable opening 30S in this embodiment) and terminates in a plurality of fiber optic connectors 50 in the opposite ends of the optical fibers 34. It should be understood that this end of the fiber optic cable may alternatively use one or more multi-fiber connectors in place of or in addition to connectors 50, or omit connectors 50 and be a non-terminated cable stub, which can then be spliced to another fiber optic cable or cables, as desired.

As another example of an additional feature, the fiber optic assembly 10 may include a drop handle 52 having a cable guide end 54. The drop handle 52 may cover the adapter panel 38 when the adapter panel 38 is not in use, and may also protect connectors that are plugged into the adapter panel 40 when the adapter panel 38 is in use. In some embodiments, the drop handle 52 may include a pivot hinge (not shown) that allows the drop handle 52 to swing up or down to provide access to the adapter panel 38. Cable guide end 54 is also configured to facilitate fiber optic connections at the front end 14 of the housing 12, for example by guiding fiber optic cables and/or optical fibers towards and away from the adapter panel 38 at the front end 14 of the housing 12. In addition, the housing 12 may include one or more guide rails 56 to facilitate guiding and aligning the fiber optic assembly 10 when the fiber optic assembly 10 is inserted into a fiber optic chassis.

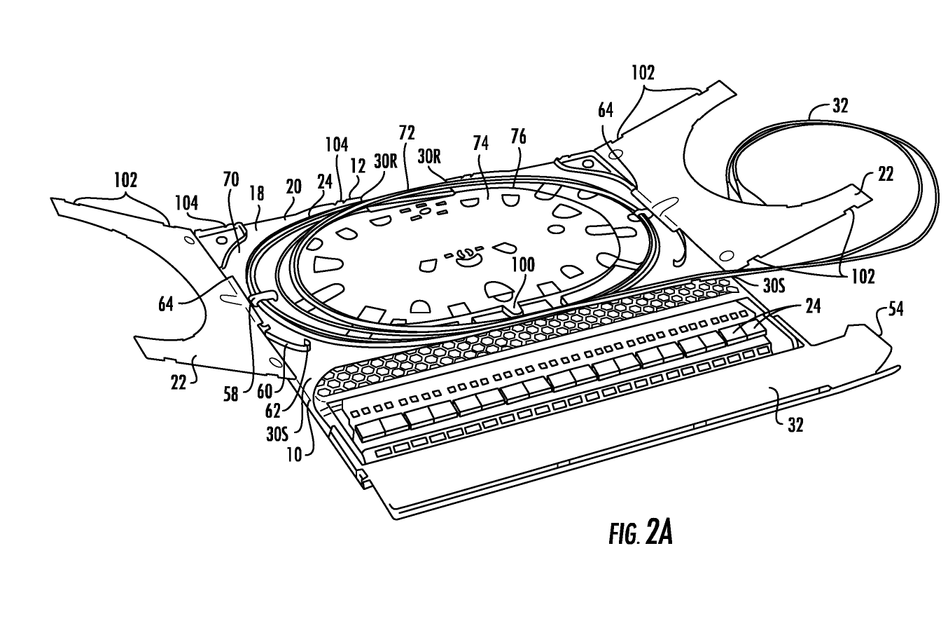

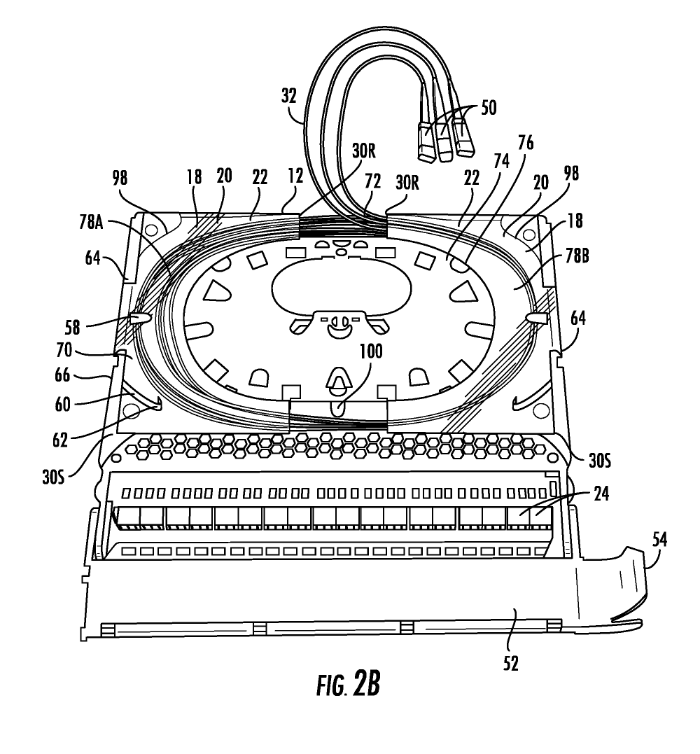

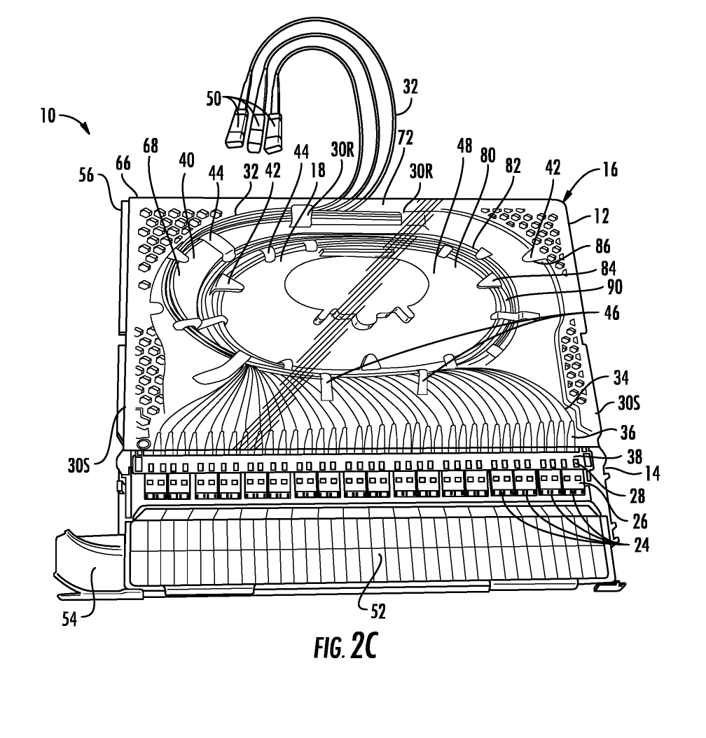

Referring now to FIG. 1B, a bottom view of the fiber optic assembly 10 of FIG. 1A is illustrated. As discussed above, the bottom of housing 12 may include a pair of transparent movable panels 22, each covering a portion of the access opening 20 of interior space 18. The interior space 18 includes additional slack storage, with additional guide tabs 58 configured to guide and retain excess length of fiber optic cable 32. As can be more clearly seen in FIG. 1B, fiber optic cable 32 is routed out of one of the cable openings 30 (cable opening 30S in this example) and out of the housing 12. As will be discussed below with respect to FIGS. 2A and 2B, by moving one or both of the panels 22 into their open position, the fiber optic cables 32 can be removed from cable opening 30S and placed in any of the other cable openings 30, such as cable openings 30R, or a different cable opening 30S. To avoid undesirable strain and bending on individual optical fibers 34, in this embodiment, one or more curved cable guides 60 is disposed proximate to one or more of the cable openings 30. Each curved cable guide 60 has a curved surface 62 having a sufficient radius of curvature to avoid bending one or more optical fibers 34 beyond an acceptable bend radius. In this manner, a fiber optic cable 32 may be coiled within the interior space 18 in either direction, while maintaining the ability to be routed through any of the plurality of cable openings 30, regardless of the direction of approach to the cable opening 30 by the fiber optic cable 32.

Referring now to FIGS. 2A and 2B, an exemplary method of reconfiguring fiber optic assembly 10 is illustrated. In FIG. 2A, the pair of panels 22 are moved to an open position to provide access to access opening 20 of interior space 18. In this embodiment, the panels are rotatably connected to the housing 12 via hinges 64. Once the interior space 18 is accessed, the fiber optic cable 32 may be removed from cable opening 30S, and moved to another cable opening 30, such as cable opening 30R in this example. Referring now to FIG. 2B, the fiber optic cable 32 is now disposed through cable opening 30R in the housing 12 such that the fiber optic cable 32 extends from the adapters disposed in the front end 14 of the housing 12 to the exterior of the housing 12 through the rear cable opening 30R in the housing 12.

Referring now to FIG. 2C, a top view of the reconfigured fiber optic assembly 10 is illustrated. In this example, the configuration of fiber optic assembly 10 is similar to the configuration illustrated by FIG. 1A, with the exception of fiber optic cable 32 extending from cable opening 30R rather than cable opening 30S, as in FIG. 1A. In this manner, fiber optic assembly 10 can be reconfigured to accommodate a number of fiber optic routing schemes.

The fiber optic assembly 10 in this embodiment is a fiber optic cassette. Exemplary fiber optic cassettes that may include additional features suitable for use with the fiber optic assembly 10 of FIGS. 2A-2C are described in commonly-owned United States Patent Application Publication 2014/0348479, which is hereby incorporated by reference for describing similar features of fiber optic cassettes, such as splice cassettes. It should also be understood that other types of fiber optic assemblies may also employ features described herein, such as, without limitation, fiber optic modules or fiber optic adapter panels. As used herein, the term “cassette” refers to a fiber optic assembly having one or more fiber optic adapters disposed therein, and configured to facilitate connection of one or more fiber optic cables therein, for example, by splicing. As used herein, the term “module” refers to a fiber optic assembly having one or more fiber optic adapters disposed therein, and configured to facilitate optical connections between and among the plurality of adapters. It should also be noted that the terms “cassette” and “module” are not mutually exclusive and may refer to similar fiber optic assemblies.

Referring now to the additional structural details of the fiber optic assembly 10 of FIGS. 2A-2C, the fiber optic assembly 10 may include a tray base 66 having a tray top surface 68 and a tray bottom surface 70. The tray base 66 may include a transition passage 72 through which a slack cable can be routed from the tray top surface 68 to the tray bottom surface 70. A tray-bottom substructure 74 may protrude from the tray bottom surface 70 and may have a substructure wall 76 between the tray-bottom substructure 74 and the tray bottom surface 70. A continuous slack passage may be defined outwardly on the tray bottom surface 70 from the substructure wall 76 of the tray-bottom substructure 74. The continuous slack passage may include a first slack region 78A and a second slack region 78B on opposite sides of the tray-bottom substructure 74, which are covered by respective panels 22.

In some embodiments, as shown in FIG. 2C, a tray center portion 80 may be defined on the tray top surface 68 inside a center-portion periphery 82. A plurality of tray cable retaining members 42 such as periphery members 84 and outer members 86 may be arranged around or outside of the center-portion periphery 82 for either or both guiding and retaining optical cables around the center-portion periphery 82. The tray center portion 80 may be a depression in the tray top surface 68 that corresponds with the tray-bottom substructure 74 on the tray bottom surface 70 (see FIG. 2B).

In some embodiments, the tray cover 48 may be made of a transparent or translucent material that enables a technician to view connections and devices on the tray base 66 through the tray cover 48. The tray base 66 may be made of a rigid material such as a plastic or polymer and may be made by any suitable technique such as molding or pressing, for example. In some embodiments, the tray center portion 80 of tray base 66 may be a depression in the center of the tray base 66, such that the center-portion periphery 82 is defined by outer walls of the depression. In other embodiments, the tray top surface 68, including the tray center portion 80, may be substantially planar, such that the center-portion periphery 82 may be defined by one or more raised features connected to the tray top surface 68.

The tray center portion 80 may be disposed within a plurality of tray cable retaining members 42 such as periphery members 88 arranged around the center-portion periphery 82. The plurality of tray cable retaining members 42 may secure the fiber optic cable 32 running within the tray center portion 80, within a cable track 90 outside the tray center portion 80, or both. Cables running within the cable track 90 may also be secured by outer members 86. The periphery members 88 and the outer members 86 may be any suitable structure that guides, catches, or secures optical cables, or that facilitates winding or wrapping of the fiber optic cable 32 along a predetermined pathway such as within the cable track 90.

The tray base 66 may include a transition passage 72 through which the fiber optic cable 32 can be routed from the tray top surface 68 to the tray bottom surface 70. The transition passage 72 may be any feature such as a notch or a hole in the tray base 66 configured such that slack cable that may be routed through the cable track 90 can be easily directed from the tray top surface 68 to the tray bottom surface 70. In this embodiment, the rear cable openings 30R, in addition to providing access for the fiber optic cable 32 out of the housing 12, may also facilitate routing the fiber optic cable 32 in and out of the transition passage 72. The tray bottom surface 70 may also contain features that allow the tray bottom surface 70 to be used to store a significant amount of slack cable that may be used by a technician during installation, repair, or replacement of the fiber optic assembly 10. Features of the tray bottom surface 70 will now be described in greater detail.

Referring back to FIG. 2B, guidance of optical cables 32 around the continuous slack passage may be facilitated by slack-passage guidance members 98 positioned at bends of the continuous slack passage. Additional guidance and retaining of optical cables may be provided by retaining members 42 such as slack-passage overhead retaining member 100.

The panels 22 may include corner securing members 102 that hold the each panel 22 in a closed position, such as during storage of the fiber optic assembly 10. Each of the corner securing members 102 may be configured as snap hooks having a resilience that enables the snap hooks to lock into the tray base 66 when the panels 22 are closed. The corner securing members 102 may lock into corresponding cover tabs 104 on the tray base 66.

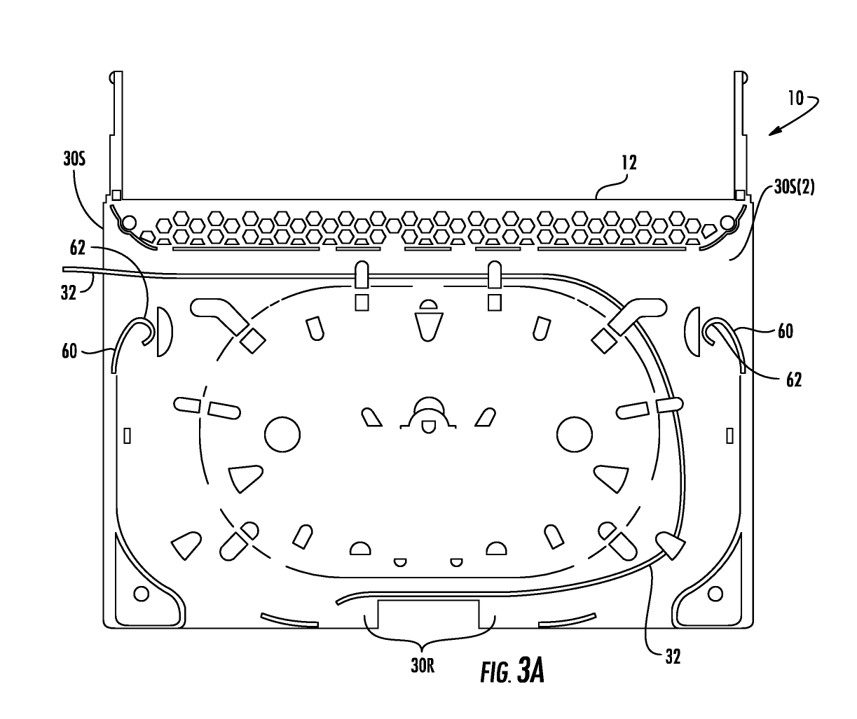

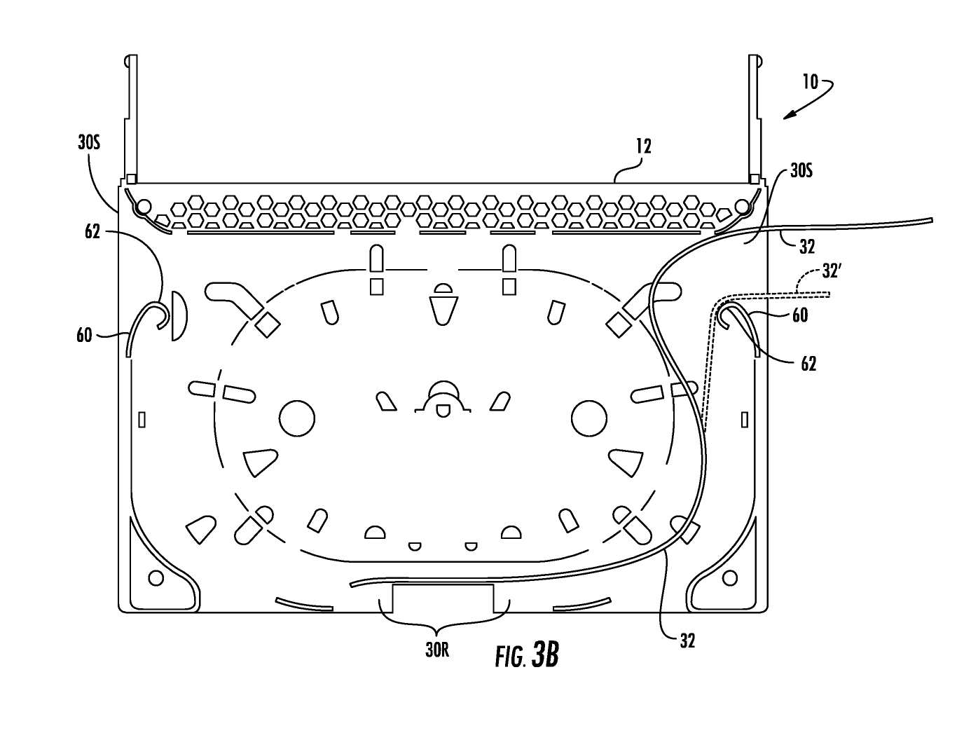

Referring now to FIG. 3, a detailed view of the cable guide 60 is illustrated. FIG. 3 illustrates how the fiber optic cable 32 is coiled in a clockwise pattern within slack regions 78A, 78B of the interior space 18 of the housing 12. The fiber optic cable 32 can easily be routed out of the left-hand side cable opening 30S(1) because the bend radius of the cable is not in danger of exceeding its bend radius parameters. However, if the fiber optic cable 32 is routed out of the right-hand cable opening 30S(2), as shown by FIG. 3B, there is greater risk of excessive bending and damage to the optical fiber because the bend radius of the fiber optic cable 32 is significantly reduced compared to the bend radius of the slack regions 78A, 78B. To prevent this from occurring, portions of the housing 12 on both sides of the slack regions 78A, 78B include cable guides 60 having a curved surface 62 that curves toward the respective cable opening 30S. Thus, even if the fiber optic cable is coiled in a direction that curves away from the respective cable opening 30S, the fiber optic cable 32 can provide strain relief for the required direction change of the fiber optic cable 32. When tension is applied to the fiber optic cable 32, as shown by dashed line representation referred to as fiber optic cable 32′, the fiber optic cable 32′ is prevented from sharply bent by the curved surface 62 of cable guide 60.

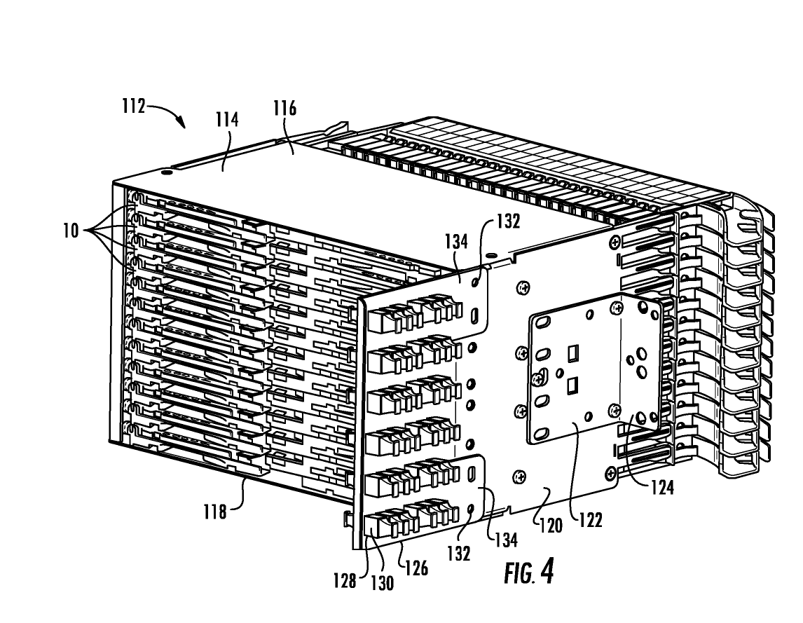

This versatility in routing fiber optic cable out of the fiber optic assembly 10 leads to added versatility when the fiber optic assembly 10 is disposed in a fiber optic chassis and/or rack configuration. In this regard, FIG. 4 illustrates a fiber optic chassis 112 in which a plurality of fiber optic assemblies 10 are disposed. The fiber optic chassis 112 includes a chassis housing 114 having a top 116, a bottom 118, and two sides 120. The sides 120 of chassis housing 114 also have mounting brackets 122 attached thereto. Each mounting bracket 122 in this embodiment includes a rack mounting flange 124 for mounting the fiber optic chassis 112 to a fiber optic rack (not shown).

In this embodiment, fiber optic chassis 112 also includes a rear adapter panel 126 attached to chassis housing 114. The rear adapter panel 126 includes a plurality of openings 128 in which a plurality of fiber optic adapters 130 are disposed. The rear adapter panel 126 also includes a plurality of mounting holes 132 arranged on a pair of chassis mounting flanges 134, to facilitate connection of the rear adapter panel 126 to the side 120 of chassis housing 114. It should be understood that while the rear adapter panel 126 in this embodiment uses mounting holes 132, such as screw holes, other mounting and/or fastening structures may be employed to attach rear adapter panel 126 to the chassis housing 114.

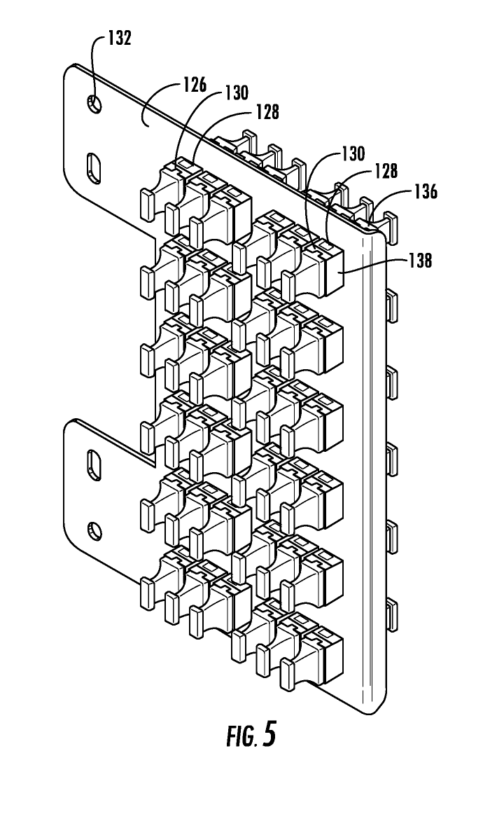

Referring now to FIG. 5, a detailed view of rear adapter panel 126 is illustrated. As shown in FIG. 5, each adapter 130 has a first end 136 on one side of the adapter panel 126 and a second side 138 disposed on the other side of the adapter panel 126. This arrangement allows fiber optic cables, such as the fiber optic cable 32 extending from the exemplary fiber optic assembly 10, to be connected to one or more adapters 130 of rear adapter panel 126. Additional fiber optic cables can then be connected directly to the stationary rear adapter panel 126, as opposed to connecting to a loose fiber optic pigtail extending from one or more of the fiber optic assemblies 10.

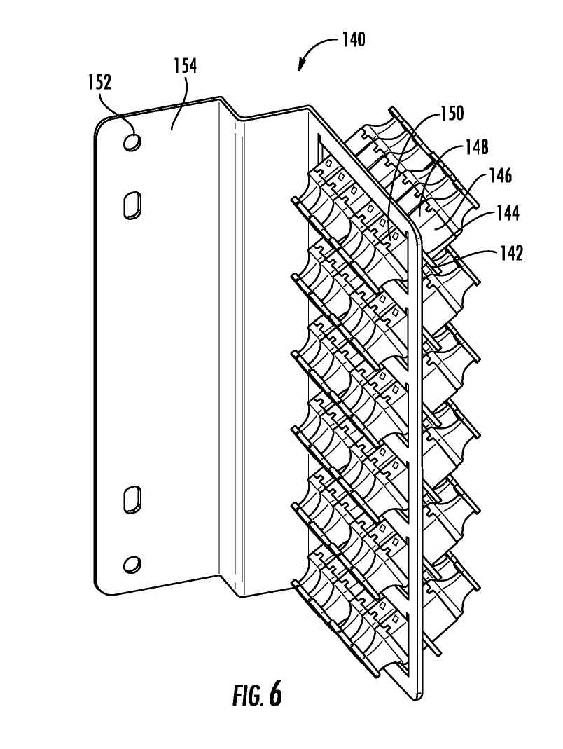

In another embodiment shown in FIG. 6, a front adapter panel 140 may instead be mounted to or approximate to a front side of chassis 112. In this embodiment, front adapter panel 140 includes a plurality of angled flanges 142, each having a plurality of openings 144 for receiving and retaining a plurality of fiber optic adapters 146. Each fiber optic adapter 146 in this embodiment has a first side 148 angled vertically upward and a second side 150 angled vertically downward. One advantage of this arrangement is that the amount of horizontal space required for connectors connected to either end of a fiber optic adapter 146 is reduced, thereby allowing the connectors connected to the front adapter panel 140 to be fit into a smaller horizontal space.

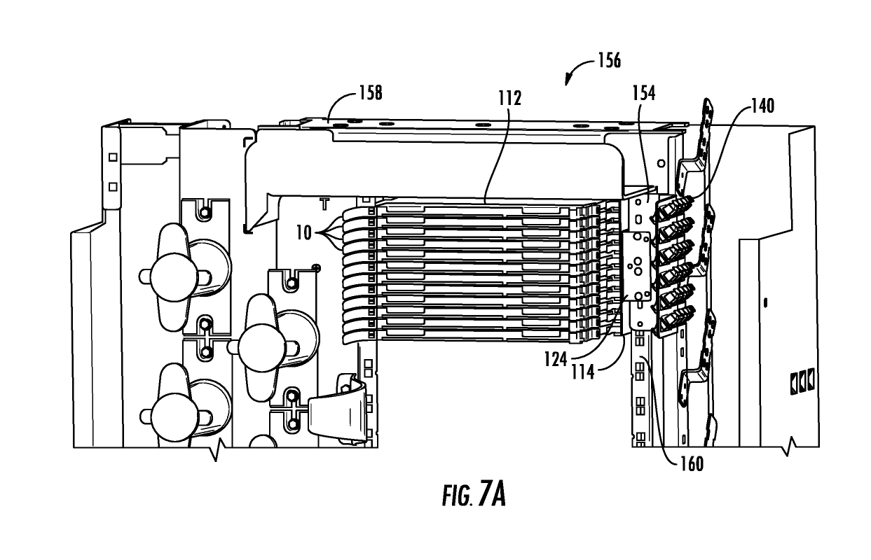

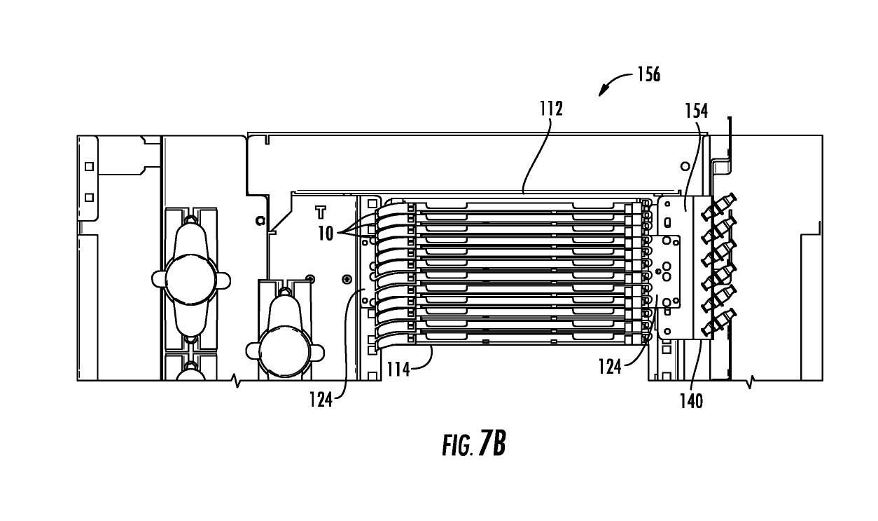

Front adapter panel 140 may be configured to be attached to a fiber optic chassis or fiber optic rack via one or more mounting holes 152 disposed in a mounting flange 154. Referring now to FIGS. 7A and 7B, a fiber optic rack 156 having a fiber optic chassis 112 mounted thereon is illustrated. In this embodiment, the fiber optic chassis 112 has a plurality of fiber optic assemblies 10 mounted therein. Fiber optic chassis 112 is also mounted to the fiber optic rack 156 via the rack mounting flanges 124 of the attached mounting brackets 122 (see FIG. 4). Fiber optic rack 156 comprises a rigid rack frame 158 including a plurality of vertical rack rails 160. In this embodiment, rack mounting flanges 124 may be removably attached to the vertical rack rails 160.

In this embodiment as well, front adapter panel 140 is also attached to one of the vertical rack rails 160 proximate to one of the rack mounting flanges 124 of the chassis 112. In this embodiment, the rack mounting 124 of fiber optic chassis 112 and the mounting flange 154 of the front adapter panel 140 are sandwiched together and may be attached to vertical rack rail 160 via common mounting holes, or, in other embodiments, may be separately and independently attached to the vertical rack rail 160.

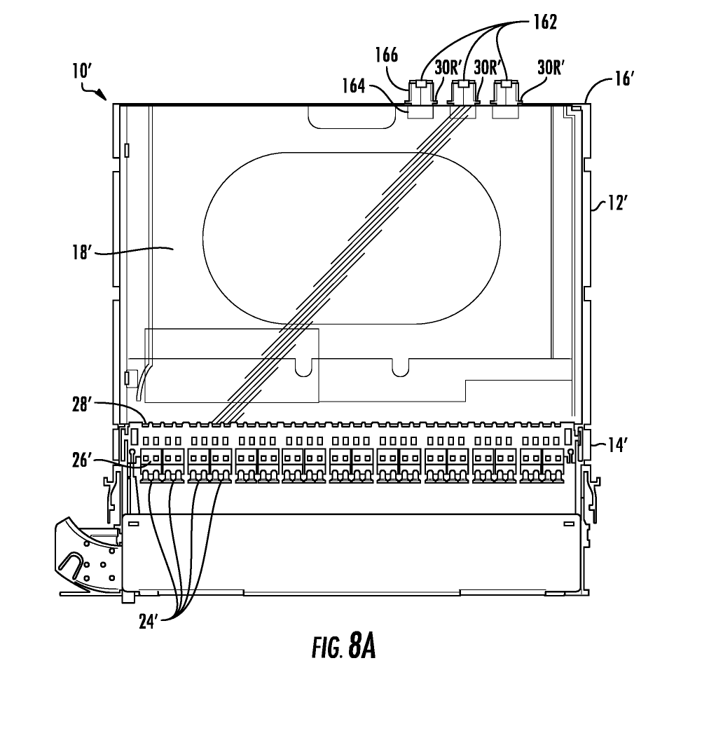

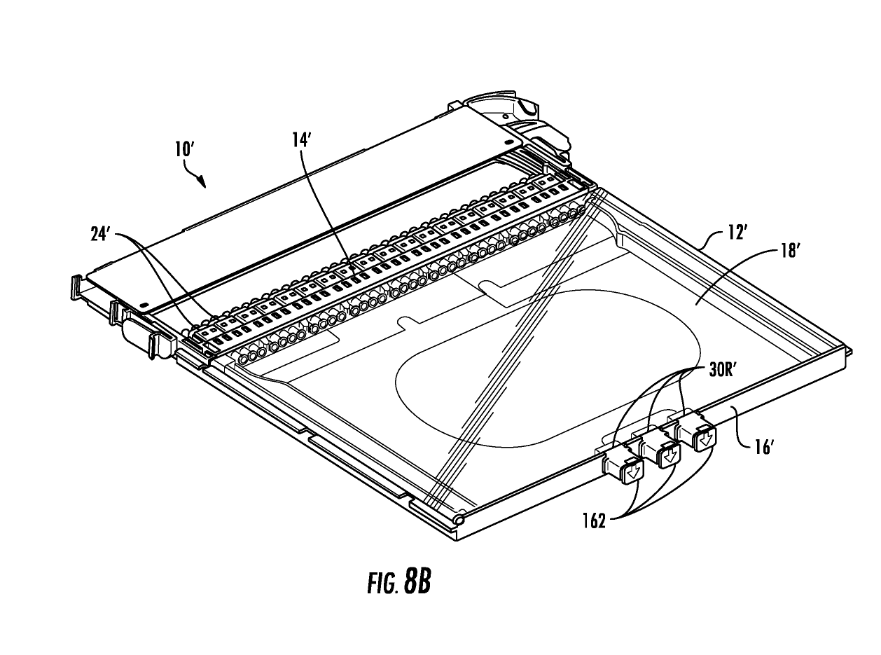

It should be understood that the additional configurations for the fiber optic assemblies described above are contemplated. In this regard, FIGS. 8A and 8B are top schematic and rear perspective views of a fiber optic assembly 10′ having a housing 12′ with a plurality of multi-fiber adapters 162 mounted in the rear end 16′ thereof, according to an alternative embodiment. In this embodiment, except where indicated, the fiber optic assembly 10′ may include similar features described above with respect to the embodiment of FIGS. 1A-2C. As with the embodiment of FIGS. 1A-2C, the housing 12′ of fiber optic assembly has a front end 14′ and a rear end 16′. The housing 12′ defines an interior space 18′ therein. The fiber optic assembly 10′ also includes a plurality of fiber optic adapters 24′, each having a front 26′ and a rear 28′ disposed in the front end 14′ of the housing 12′. The front 26′ of each fiber optic adapter 24′ is accessible from the front end 14′ of the housing 12′ when the fiber optic assembly 10′ is mounted in a fiber optic chassis, such as fiber optic chassis 112 of FIG. 4. The fiber optic assembly 10′ also includes a plurality of cable openings 30′ in the housing 12′.

In the embodiment of FIGS. 8A and 8B, one or more of the plurality of cable openings 30′ are sized and adapted to receive and support one or more multi-fiber adapters 162 for receiving one or more multifiber connectors (not shown). In this embodiment, multi-fiber adapter 162 are mounted in rear cable opening 30R′. Each multi-fiber adapter 162 has a front end 164 disposed inside the interior space 18′ and a rear end 164 disposed outside the interior space 18′. Thus, in this embodiment, connectorized cables (not shown) may be routed between and among the fiber optic adapters 24′ and multi-fiber adapters 162. Connectorized cables may also be moved and rerouted between and among the fiber optic adapters 24′ and multi-fiber adapters 162, in order to reconfigure the fiber optic assembly 10′ as desired. In this manner, the fiber optic adapters 24′ and multi-fiber adapters 162 may provide connection points for one or more fiber optic connectors at different points on the housing 12′ of fiber optic assembly 10′, in order to provide easier and more efficient access and reconfigurability to the fiber optic cabling therein.

It should be understood that multi-fiber adapters 162 may be disposed anywhere on the housing 12′. In this regard, FIG. 9 is a front perspective view of a fiber optic assembly 10″ having a housing 12″ with single fiber adapters 24″ and multi-fiber adapters 162″ mounted in the front end 14″ thereof, according to an alternative embodiment. In this embodiment, as with the embodiment of FIGS. 8A and 8B, the fiber optic assembly 10″ may include similar features described above with respect to the embodiment of FIGS. 1A-2C, except where indicated. As with the embodiment of FIGS. 1A-2C, the housing 12″ of fiber optic assembly has a front end 14″ and a rear end 16″. The housing 12″ defines an interior space 18″ therein. The fiber optic assembly 10″ also includes a plurality of fiber optic adapters 24″, each having a front 26″ and a rear 28″ disposed in the front end 14″ of the housing 12″. The front 26″ of each fiber optic adapter 24″ is accessible from the front end 14″ of the housing 12″ when the fiber optic assembly 10″ is mounted in a fiber optic chassis, such as fiber optic chassis 112 of FIG. 4. The fiber optic assembly 10′ also includes a plurality of cable openings 30″ in the housing 12″.

In this embodiment, one or more multi-fiber adapters 162″ are mounted in a front cable opening 30F″ adjacent to the fiber optic adapters 24″ disposed in the front end 14″ of the housing 12″. Each multi-fiber adapter 162″ has a front end 164″ disposed inside the interior space 18″ and a rear end 166″ disposed outside the interior space 18′. Thus, in this embodiment, connectorized cables (not shown) may be routed between and among the fiber optic adapters 24″ and multi-fiber adapters 162″, similar to the embodiment of FIGS. 8A and 8B.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is no way intended that any particular order be inferred.

It will be apparent to those skilled in the art that various modifications and variations can be made without departing from the spirit or scope of the disclosure. Since modifications combinations, sub-combinations and variations of the disclosed embodiments incorporating the spirit and substance of the disclosure may occur to persons skilled in the art, the disclosure should be construed to include everything within the scope of the appended claims and their equivalents.

What is claimed is:

1. A fiber optic assembly comprising:
a housing having a front end and a rear end, the housing defining an interior space therein;
at least one access opening in the housing;
at least one panel connected to the housing and movable between a closed position covering at least part of the at least one access opening, and an open position;
a plurality of adapters each having a front end and a rear end disposed in the front end of the housing such that the front end of each of the plurality of adapters is accessible from the front end of the housing when the fiber optic assembly is mounted in a fiber optic chassis; and
a plurality of cable openings in the housing configured to route at least one fiber optic cable connected to at least one of the plurality of adapters out of the housing;
wherein, when the at least one panel is moved into the open position, at least one fiber optic cable connected to at least one of the plurality of adapters is movable from one of the plurality of cable openings to another of the plurality of cable openings.

2. The fiber optic assembly of claim 1, wherein at least one of the plurality of cable openings is located in a side wall of the housing extending between the front end and the rear end of the housing.

3. The fiber optic assembly of claim 2, wherein the at least one of the plurality of cable openings is located in the rear end of the housing.

4. The fiber optic assembly of claim 2, wherein the at least one of the plurality of cable openings is located in the front end of the housing.

5. The fiber optic assembly of claim 1, wherein at least one of the plurality of cable openings is located in the rear end of the housing.

6. The fiber optic assembly of claim 5, wherein at least one of the plurality of cable openings is located in the front end of the housing.

7. The fiber optic assembly of claim 1, wherein at least one of the plurality of cable openings is located in the front end of the housing.

8. The fiber optic assembly of claim 1, wherein the assembly is a fiber optic cassette.

9. The fiber optic assembly of claim 1, wherein the assembly is a fiber optic module.

10. The fiber optic assembly of claim 1, further comprising at least one cable guide disposed in the housing proximate at least one of the plurality of cable openings, the at least one cable guide having at least one curved surface configured to guide and provide strain relief to the at least one fiber optic cable when the fiber optic cable is disposed in the respective cable opening.

11. The fiber optic assembly of claim 1, wherein the at least one panel is removably connected to the housing.

12. A fiber optic system comprising:
a chassis housing defining an interior;
at least one fiber optic assembly mounted in the interior of the chassis, each fiber optic assembly comprising:
a housing having a front end and a rear end, the housing defining an interior space therein;
at least one access opening in the housing;
at least one panel connected to the housing and movable between a closed position removably covering at least part of the at least one access opening, and an open position;
a plurality of adapters each having a front end and a rear end disposed in the front end of the housing such that the front end of each of the plurality of adapters is accessible from the front end of the housing when the fiber optic assembly is mounted in a fiber optic chassis; and
a plurality of cable openings in the housing configured to route at least one fiber optic cable connected to at least one of the plurality of adapters out of the housing;
wherein, when the at least one panel of the at least one one fiber optic assembly is moved into the open position, at least one fiber optic cable connected to at least one of the plurality of adapters is movable from one of the plurality of cable openings to another of the plurality of cable openings.

13. The fiber optic chassis of claim 12, further comprising at least one adapter panel comprising a plurality of fiber optic adapters mounted therethrough and configured to receive the at least one fiber optic cable extending from at least one of the cable openings therein.

14. The fiber optic assembly of claim 13, wherein the at least one adapter panel is located proximate to the rear end of the housing.

15. The fiber optic assembly of claim 13, wherein the at least one adapter panel is located proximate to the front end of the housing.

16. The fiber optic assembly of claim 13, wherein the plurality of fiber optic adapters is disposed at an oblique angle with respect to the at least one adapter panel.

17. The fiber optic assembly of claim 13, wherein the at least one adapter panel is mounted on the chassis housing.

18. The fiber optic assembly of claim 13, further comprising a fiber optic equipment rack, wherein the chassis housing is mounted on the fiber optic equipment rack, and the at least one adapter panel is mounted on the fiber optic equipment rack.

19. A method of reconfiguring a fiber optic assembly, the fiber optic assembly having a front end and a rear end and defining an interior space therein, the method comprising:
accessing the interior space of the fiber optic assembly via at least one access opening in a housing;
removing a fiber optic cable extending from one or more adapters disposed in a front end of the housing to an exterior of the housing through a first cable opening in the housing;
disposing the fiber optic cable through a second cable opening in the housing such that the fiber optic cable extends from the one or more adapters disposed in the front end of the housing to the exterior of the housing through the second cable opening in the housing.

20. The method of claim 19, further comprising:
connecting the fiber optic cable to one or more fiber optic adapters disposed in an adapter panel disposed outside the fiber optic assembly, such that the fiber optic cable extends from the one or more adapters disposed in the front end of the housing to the one or more fiber optic adapters disposed in the adapter panel through the second cable opening in the housing.
